(19) United States
(12) Patent Application Publication
(10) Pub. No.: US 2017/0330675 A1
(43) Pub. Date: Nov. 16, 2017

(54) COMMON MODE FILTER

(71) Applicant: SAMSUNG ELECTRO-MECHANICS CO., LTD., Suwon-si (KR)

(72) Inventors: Won Chul SIM, Suwon-si (KR); Hye Won BANG, Suwon-si (KR); Hyung Jin JEON, Suwon-si (KR)

(21) Appl. No.: 15/406,248

(22) Filed: Jan. 13, 2017

(30) Foreign Application Priority Data
May 16, 2016 (KR) 10-2016-0059502

(51) Int. Cl. H01F 27/255; H01F 27/28

(52) U.S. Cl. CPC H01F 27/255; H01F 27/2804

(57) ABSTRACT

A common mode filter includes a lower cover layer including a first magnetic particle, a filter layer disposed on an upper surface of the lower cover layer, and including a coil portion including a plurality of coils and a coil peripheral portion including a second magnetic particle, and an upper cover layer disposed on an upper surface of the filter layer and including the first magnetic particle.

### CROSS-REFERENCE TO RELATED APPLICATION(S)

This application claims the benefit of priority to Korean Patent Application No. 10-2016-0059502, filed on May 16, 2016 in the Korean Intellectual Property Office, the entire disclosure of which is incorporated herein by reference.

### TECHNICAL FIELD

The present disclosure relates to a common mode filter.

### BACKGROUND

As technology advances, electronic devices such as mobile phones, home appliances, personal computers (PC), personal digital assistants (PDA), and liquid crystal displays (LCD) have changed to use a digital scheme, rather than an analog scheme, and thus, processing speeds thereof have increased, according to an increase in data throughput. Thus, USB 2.0, USB 3.0, and high definition multimedia interfaces (HDMI) have come into widespread use as high-speed signal transmission interfaces, and such interfaces have been used in a range of digital devices, such as personal computers and digital high-definition television sets.

Such high-speed interfaces employ a differential signal system therein, transmitting differential signals, for example, differential mode signals, using a pair of signal lines, in a manner different from a single-end transmission system, which has been commonly used for a long period of time. However, since digitized and high-speed electronic devices are sensitive to external stimulation, signal distortion may be caused by high-frequency noise.

Causes of the occurrence of such abnormal voltages and noise include a switching voltage generated in circuits, power noise included in a power supply voltage, unnecessary electromagnetic signals or electromagnetic noise, and the like. As a means of preventing such abnormal voltage and high-frequency noise from being introduced into circuits, a common mode filter (CMF) has been used.

As mobile devices have been high-speed and multi-functional, the employment of interfaces for high-speed data transmission, for example, USB 3.1: 5 to 10 Gbps, has increased. Thus, in the case of common mode filters installed on differential lines to remove common mode noise, a scheme able to reduce transmission loss is also required.

In order to implement low-loss transmission characteristics of common mode filters, a structure in which a magnetic substance is disposed in the interior of a common mode filter as well as in upper and lower portions thereof to thus form a closed-magnetic path is required, and in this case, the number of coil turns and a length thereof to implement a required capacity need to be significantly reduced.

However, in the case of a common mode filter operating in the GHz frequency band, since noise attenuation characteristics may be deteriorated due to a decrease in permeability of a magnetic substance and an increase in magnetic loss (Tan δ), a problem in which common mode noise may not be effectively removed has been present. Accordingly, a common mode filter able to effectively reduce noise while reducing transmission loss is required.

### SUMMARY

An aspect of the present disclosure may provide a common mode filter able to effectively reduce noise while reducing transmission loss.

According to an aspect of the present disclosure, a common mode filter includes a lower cover layer including a first magnetic particle, a filter layer disposed on an upper surface of the lower cover layer, and including a coil portion including a plurality of coils and a coil peripheral portion including a second magnetic particle, and an upper cover layer disposed on an upper surface of the filter layer and including the first magnetic particle.

According to another aspect of the present disclosure, a common mode filter includes a lower cover layer, a filter layer disposed on an upper surface of the lower cover layer, and including a coil portion including a plurality of coils and a coil peripheral portion, and an upper cover layer disposed on an upper surface of the filter layer. The coil peripheral portion includes a coil center portion including a first magnetic particle and a coil outer portion including a second magnetic particle.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic perspective view of a common mode filter according to an exemplary embodiment in the present disclosure;

FIG. 2 is a schematic cross-sectional view taken along line I-I′ of FIG. 1;

FIG. 3 is a captured image illustrating a structure of spinel ferrite, and FIG. 4 is a captured image illustrating a structure of hexaferrite; and

FIG. 5 is a graph illustrating transmission characteristics and attenuation characteristics of a common mode filter according to a comparative example (represented by a broken line) and transmission characteristics and attenuation characteristics of a common mode filter according to an exemplary embodiment (represented by a solid line) in the present disclosure.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on, ” “connected to, ” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” relative to other elements would then be oriented “below,” or “lower” relative to the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present disclosure will be described with reference to schematic views illustrating embodiments of the present disclosure. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape results in manufacturing. The following embodiments may also be constituted by one or a combination thereof.

The contents of the present disclosure described below may have a variety of configurations and propose only a required configuration herein, but are not limited thereto.

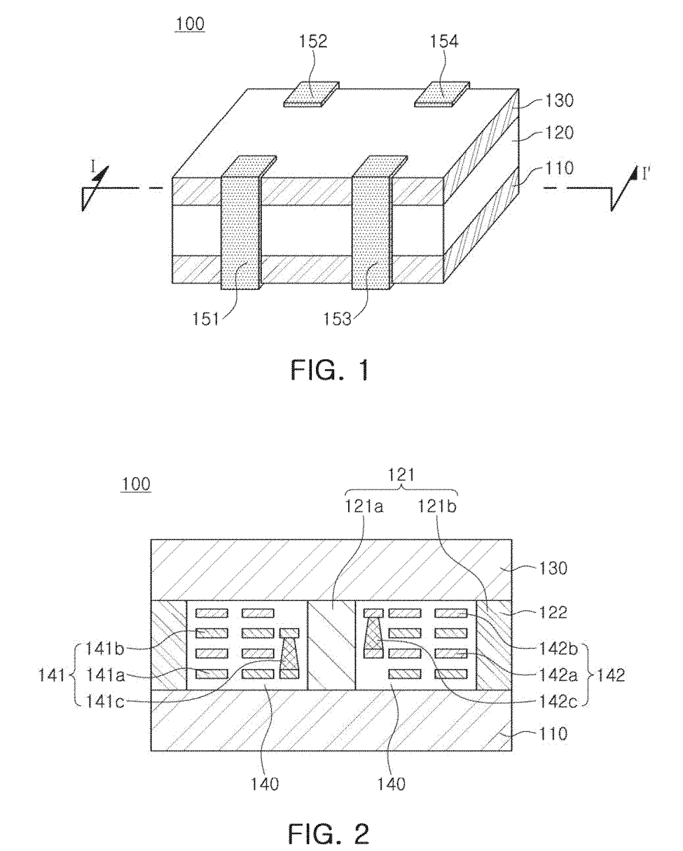

FIG. 1 is a schematic perspective view of a common mode filter 100 according to a first exemplary embodiment in the present disclosure, and FIG. 2 is a schematic cross-sectional view taken along line I-I′ of FIG. 1.

A configuration of the common mode filter 100 according to the first exemplary embodiment will be described with reference to FIGS. 1 and 2. The common mode filter 100 may include a filter layer 120 including one or more coil electrode layers 141 and 142 having a helical form, and cover layers 110 and 130 disposed on upper and lower portions of the filter layer 120.

External electrodes 151, 152, 153 and 154 may be disposed on outer surfaces of the lower cover layer 110, the filter layer 120, and the upper cover layer 130.

The lower cover layer 110 and the upper cover layer 130 may include first magnetic particles. For example, the lower cover layer 110 and the upper cover layer 130 may be formed by manufacturing a sheet using a magnetic composition including a first magnetic particle and a resin.

The filter layer 120 may include a coil portion 140 including a plurality of coils, and a coil peripheral portion 121 disposed in the vicinity of the coil portion 140.

The coil portion 140 may include a first coil 141 and a second coil 142, but is not limited thereto. The number of coils may be changed as needed.

For example, the coil portion 140 may include four-layer coils as illustrated in FIG. 2.

For clarity of description, a four-layer coil of the coil portion 140 may be defined as a 1-1 coil 141a, a 2-1 coil 142a, a 1-2 coil 141b, and a 2-2 coil 142b from a lower portion thereof, but is not limited thereto.

A first external electrode 151 may be connected to the 1-1 coil 141a, and the 1-1 coil 141a may be connected to the 1-2 coil 141b via a first conductive via 141c passing through upper and lower portions of the coil portion. The 1-2 coil 141b maybe connected to a second external electrode 152. Thus, the first coil 141 having a helical form may be formed.

In a manner similar thereto, a third external electrode 153 may be connected to the 2-1 coil 142a, and the 2-1 coil 142a may be connected to the 2-2 coil 142b via a second conductive via 142c passing through upper and lower portions of the coil portion. The 2-2 coil 142b may be connected to a fourth external electrode 154. Thus, the second coil 142 having a helical form may be formed.

Inductance and capacitance may be formed via the respective coils connected as described above, thereby attenuating noise of a common mode signal.

The coil peripheral portion 121 may be disposed in the vicinity of the coil portion 140.

The coil peripheral portion 121 may be disposed within the filter layer 120, and may include a coil center portion 121a located in a center of the coil portion 140 and a coil outer portion 121b located outside of the coil portion 140.

For example, when the lower cover layer 110 or the upper cover layer 130 includes the first magnetic particles, the coil peripheral portion 121 may include second magnetic particles.

The first and second magnetic particles may be formed of different materials, or may indicate magnetic particles having different average particle sizes.

The first magnetic particles may be spinel ferrite particles, and the second magnetic particles may be hexaferrite particles.

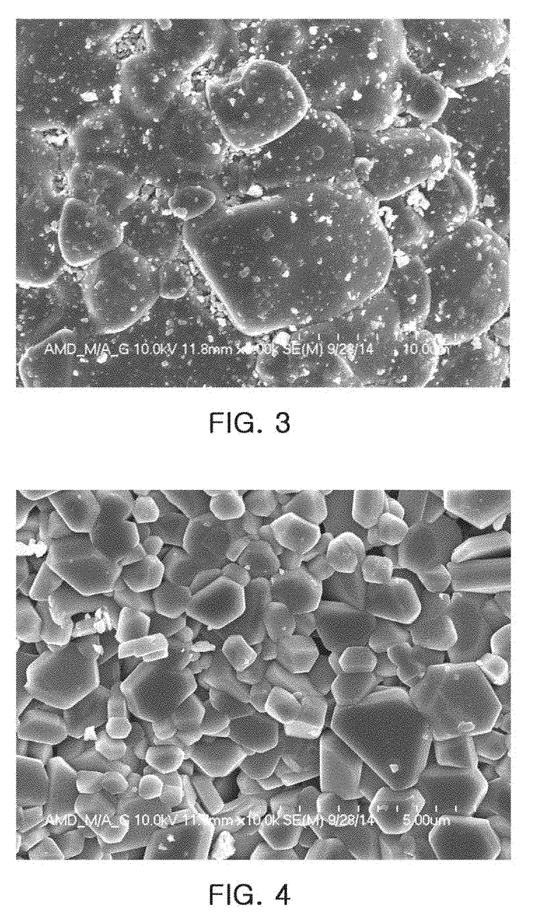

The shapes and properties of spinel ferrite and hexaferrite may be referred to FIGS. 3 and 4 and the following Table 1.

TABLE 1

| | Spinel-ferrite | Hexaferrite |
|---|---|---|
| Magnetic Loss | 1.93 (Range: 1.0 or | 0.04 (Range: 0.01~1.0) |
| (Tan δ) | more) | |
| Composition | Ni—Fe—Zn—Mn—Mg | Ba—Fe—Co—Ni—Zn—Mn |
| Structure | Spinel | Hexagonal |

In this case, it can be appreciated that magnetic loss (Tan δ) of hexaferrite is significantly reduced as compared to that of spinel ferrite. In the case of spinel ferrite, a magnetic loss (Tan δ) value of 1.0 or more may be provided in a 1 GHz region in which the common mode filter operates, and in the case of hexaferrite, a relatively low magnetic loss (Tan δ) value of about 0.01 to 0.1 may be provided. The ranges described above may be changed according to a composition of respective magnetic materials and the contents of powder and a resin.

In order to implement low-loss transmission characteristics in a common mode filter, a structure in which a magnetic substance is disposed in the interior of a common mode filter as well as in upper and lower portions thereof to thus form a closed-magnetic path may be required, and in this case, the number of coil turns and a length thereof to implement a required capacity may be significantly reduced.

In the case of a common mode filter operating in the GHz frequency band, since noise attenuation characteristics may be deteriorated due to a decrease in permeability of a magnetic substance and an increase in magnetic loss (Tan δ), a problem in which common mode noise may not be effectively removed may be present.

Spinel ferrite has positive attributes in that permeability is relatively high in a low frequency band, while having negative attributes in that permeability is sharply reduced in a high frequency domain such as a GHz band and magnetic loss is increased, and thus, may have a problem in which attenuation characteristics decrease. On the other hand, the magnetic permeability of hexaferrite is maintained in a high frequency domain (GHz) and loss is reduced. In addition, since the magnetic permeability of hexaferrite is relatively low in a low frequency domain of about 100 MHz as compared to spinel ferrite, the number of coil turns required in implementing the same capacity as that of the spinel ferrite should be increased, and thus, transmission loss is increased.

However, in the case of the common mode filter according to the first exemplary embodiment in the present disclosure, the upper or lower cover layer 130 or 110 may be formed of the first magnetic particles, and the coil peripheral portion 121 may be formed of the second magnetic particles, thereby significantly reducing the number of coil turns required for the implementation of capacity to thus significantly decrease transmission loss, and in addition, improving attenuation characteristics in a high frequency domain.

For example, when the first magnetic particles are spinel ferrite particles and the second magnetic particles are hexaferrite particles, the upper and lower cover layers 130 and 110 may have high permeability in a low frequency domain, and the coil peripheral portion 121a may have low-loss characteristics in a high frequency domain, thereby significantly reducing the number of coil turns required for the implementation of capacity, to thus significantly decrease transmission loss, and in addition, improving attenuation characteristics in a high frequency domain.

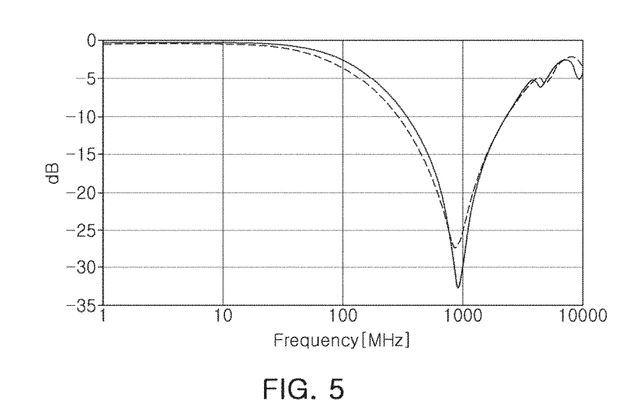

In detail, as illustrated in FIG. 5, it can be seen that compared to transmission characteristics and attenuation characteristics of a common mode filter in a comparative example (represented by a broken line), transmission characteristics and attenuation characteristics of the common mode filter according to an exemplary embodiment (represented by a solid line) are improved.

In the graph of FIG. 5, an x-axis indicates a frequency and a y-axis indicates attenuation characteristics. In a 1 GHz frequency band, the attenuation characteristics in the comparative example (represented by the broken line) are −25 dB, while the attenuation characteristics of the common mode filter according to the exemplary embodiment (represented by a solid line) are −30 dB, in which the attenuation characteristics have been further improved by −5 dB, and thus, it can be seen that improved attenuation characteristics are provided in the exemplary embodiment.

Alternatively, the first magnetic particles may be hexaferrite particles, and the second magnetic particles may be spinel ferrite particles, thereby controlling required characteristics. In this case, the structure in which in the entirety of a chip, a volume of hexaferrite having relatively low magnetic loss is greater than a volume of spinel ferrite filling a central portion of a filter portion and a peripheral portion thereof, may be provided. Thus, magnetic loss may be reduced. Thus, as compared to the case in which the first magnetic particles are spinel ferrite particles and the second magnetic particles are hexaferrite particles, the attenuation effect of the common mode filter may be improved.

In the case of a common mode filter 100 according to a second exemplary embodiment, a first magnetic particle and a second magnetic particle may have different particle sizes.

For example, an average particle size of the second magnetic particle included in the coil peripheral portion 121 may be less than an average particle size of the first magnetic particle included in the upper and lower cover layers 130 and 110.

In a process of manufacturing the filter layer 120, the coil center portion 121a and the coil outer portion 121b may be formed by forming a through-structure and then pressing a magnetic composite sheet including magnetic particles and a resin inside the through-structure to fill the through-structure.

In this case, since a diameter of the through-structure may be relatively narrow, for example, within 100 μm, a portion of the coil peripheral portion 121 may not be filled, or only a resin may be present, thus decreasing magnetic permeability.

However, in the case of the common mode filter 100 according to the second exemplary embodiment, since an average particle size of the second magnetic particle included in the coil peripheral portion 121 is less than an average particle size of the first magnetic particle included in the upper and lower cover layers 130 and 110, a problem such as the occurrence of a non-filled region or the occurrence of a region in which only a resin is formed may be prevented.

In addition, since the particle size of the first magnetic particle included in the upper and lower cover layers 130 and 110 is greater than that of the second magnetic particle, the upper and lower cover layers 130 and 110 may have relatively high permeability as compared to the coil peripheral portion 121, and thus, the first magnetic particles included in the upper and lower cover layers 130 and 110 may compensate for reductions in magnetic permeability of the coil peripheral portion 121.

In the case of the common mode filter 100 according to the second exemplary embodiment, the first magnetic particles may be spinel ferrite particles, and the second magnetic particles may be hexaferrite particles. Alternatively, in reverse, the first magnetic particles may be hexaferrite particles, and the second magnetic particles may be spinel ferrite particles.

Alternatively, the first magnetic particles and the second magnetic particles may be hexaferrite particles, or may be spinel ferrite particles.

In the case of a common mode filter 100 according to a third exemplary embodiment, a coil center portion 121a may include first magnetic particles, and a coil outer portion 121b may include second magnetic particles.

In addition, upper and lower cover layers 130 and 110 may also include the second magnetic particles identical to that of a coil outer portion 121b.

Alternatively, upper and lower cover layers 130 and 110 may also include the first magnetic particles identical to that of a coil center portion 121a.

The first and second magnetic particles may be different materials, or may indicate magnetic particles having different particle sizes.

The first magnetic particles may be hexaferrite particles, and the second magnetic particles may be spinel ferrite particles.

In order to implement low-loss transmission characteristics in the common mode filter, a structure in which a magnetic substance is disposed in the interior of the common mode filter as well as upper and lower portions thereof to thus form a closed-magnetic path may be required, and in this case, the number of coil turns and a length thereof to implement a required capacity may be significantly reduced.

In the case of the common mode filter operating in a GHz frequency band, since noise attenuation characteristics may be deteriorated due to a decrease in permeability of a magnetic substance and an increase in magnetic loss (Tan δ), a problem in which common mode noise may not be effectively removed may be present.

Thus, for example, when hexaferrite is included, as a first magnetic particle, in the coil center portion 121a corresponding to a core portion of the coil portion 140, low-loss characteristics may be provided in a high frequency domain, thereby significantly reducing the number of coil turns required for the implementation of capacity to thus significantly decrease transmission loss, and in addition, improving attenuation characteristics in a high frequency domain. In addition, for example, when spinel ferrite is included, as a second magnetic particle, in the coil outer portion 121b, high permeability may be provided in a low frequency domain.

In the case of the common mode filter 100 according to the third exemplary embodiment, the number of coil turns required for the implementation of capacity may be significantly reduced, to thus significantly decrease transmission loss and improve attenuation characteristics in a high frequency domain.

Alternatively, the first magnetic particle may be a spinel ferrite particle, and the second magnetic particle may be a hexaferrite particle, thereby controlling required characteristics.

In the case of a common mode filter 100 according to a fourth exemplary embodiment, a first magnetic particle and a second magnetic particle may have different particle sizes.

For example, an average particle size of the first magnetic particle included in a coil center portion 121a may be less than an average particle size of the second magnetic particle included in a coil outer portion 121b.

In a process of manufacturing a filter layer 120, the coil center portion 121a and the coil outer portion 121b may be formed by forming a through-structure and then pressing a magnetic composite sheet including magnetic particles and a resin inside the through-structure to fill the through-structure.

In this case, since a diameter of the through-structure is relatively narrow, for example, within 100 μm, a portion of a coil peripheral portion 121 may not be filled, or only a resin may be filled, thus decreasing magnetic permeability. For example, in a case in which a portion of the coil center portion 121 is not filled or only a resin is present, a reduction in magnetic permeability of a common mode filter may be further increased.

However, in the case of the common mode filter 100 according to the fourth exemplary embodiment, since an average particle size of the first magnetic particle included in the coil center portion 121a is less than an average particle size of the second magnetic particle included in the coil outer portion 121b, a problem such as the occurrence of a non-filled region or the occurrence of a region in which only a resin is formed may be prevented.

In addition, since the particle size of the second magnetic particle included in the coil outer portion 121b is greater than that of the first magnetic particle, the coil outer portion 121b may have relatively high permeability as compared to the coil center portion 121a. Thus, the second magnetic particles included in the coil outer portion 121b may compensate for a reduction in magnetic permeability of the coil peripheral portion 121.

In the case of the common mode filter 100 according to the fourth exemplary embodiment, the first magnetic particles may be spinel ferrite particles, and the second magnetic particles may be hexaferrite particles. Alternatively, in reverse, the first magnetic particles may be hexaferrite particles, and the second magnetic particles may be spinel ferrite particles.

Alternatively, an average particle size of the first magnetic particle included in a coil center portion 121a may be greater than an average particle size of the second magnetic particle included in a coil outer portion 121b.

Furthermore, the first magnetic particles and the second magnetic particles may be hexaferrite particles, or may be spinel ferrite particles.

As set forth above, in the case of a common mode filter according to an exemplary embodiment, first magnetic particles may be included in upper and lower cover layers, and second magnetic particles may be included in a filter layer, whereby noise may be effectively attenuated simultaneously with a reduction in transmission loss.

While exemplary embodiments have been shown and described above, it will be apparent to those skilled in the art that modifications and variations could be made without departing from the scope of the present inventive concept as defined by the appended claims.

What is claimed is:

1. A common mode filter comprising:
a lower cover layer including a first magnetic particle;
a filter layer disposed on an upper surface of the lower cover layer, and including a coil portion including a plurality of coils and a coil peripheral portion including a second magnetic particle; and
an upper cover layer disposed on an upper surface of the filter layer, and including the first magnetic particle.

2. The common mode filter of claim 1, wherein the first magnetic particle is a spinel ferrite particle, and the second magnetic particle is a hexaferrite particle.

3. The common mode filter of claim 1, wherein the first magnetic particle is a hexaferrite particle, and the second magnetic particle is a spinel ferrite particle.

4. The common mode filter of claim 1, wherein an average particle size of the first magnetic particle is greater than an average particle size of the second magnetic particle.

5. The common mode filter of claim 4, wherein the first magnetic particle and the second magnetic particle are hexaferrite particles or spinel ferrite particles.

6. A common mode filter comprising:
a lower cover layer;
a filter layer disposed on an upper surface of the lower cover layer, and including a coil portion including a plurality of coils and a coil peripheral portion; and
an upper cover layer disposed on an upper surface of the filter layer,
wherein the coil peripheral portion includes a coil center portion including a first magnetic particle and a coil outer portion including a second magnetic particle.

7. The common mode filter of claim 6, wherein the first magnetic particle is a hexaferrite particle, and the second magnetic particle is a spinel ferrite particle.

8. The common mode filter of claim 6, wherein the first magnetic particle is a spinel ferrite particle, and the second magnetic particle is a hexaferrite particle.

9. The common mode filter of claim 6, wherein an average particle size of the first magnetic particle is less than an average particle size of the second magnetic particle.

10. The common mode filter of claim 6, wherein an average particle size of the first magnetic particle is greater than an average particle size of the second magnetic particle.

11. The common mode filter of claim 9, wherein the first magnetic particle and the second magnetic particle are hexaferrite particles or spinel ferrite particles.

12. The common mode filter of claim 9, wherein the upper and lower cover layers include the first magnetic particle.

13. The common mode filter of claim 9, wherein the upper and lower cover layers include the second magnetic particle.
